(19) United States
(12) Patent Application Publication
(10) Pub. No.: US 2005/0257378 A1
(43) Pub. Date: Nov. 24, 2005

(54) Barber's scissors

(76) Inventor: Hidemi Adachi, Gifu (JP)

Correspondence Address: MURAMATSU & ASSOCIATES, 114 Pacifica, Suite 310, Irvine, CA, 92618, US

(21) Appl. No.: 10/518,336

(22) PCT Filed: Apr. 14, 2003
(86) PCT No.: PCT/JP03/04733

§ 371 Date: Dec. 15, 2004

(51) Int. Cl. B26B 13/00; B26B 19/00

(52) U.S. Cl. 30/194

(57) ABSTRACT

A pair of hairdressing scissors can easily accommodate the hands and fingers of each user such as the thickness and length by bending the finger grip to a desired size and shape. Further, the hairdressing scissors has minimum limitations when changing the size of the finger grip. The hairdressing scissors do not cause discomfort to the fingers in the finger grips. The hairdressing scissors 1 include two shear bodies 2 joined together each having a blade 3 is on a front end A and a finger grip 4 on a back end B. The finger grip 4 is provided with a slit 6 and is configured by a shape and material that enable plastic deformation to be widened or narrowed. Both end portions 7 of the slit 6 are formed so that a side surface of each end portion passes one another.

### FILED OF THE TECHNOLOGY

This invention relates to an improvement of hairdressing scissors, and more particularly, to hairdressing scissors with finger grips that accommodate the size of the fingers of a user by changing the finger grips of the scissors to a desired size.

### BACKGROUND TECHNOLOGY

A pair of hairdressing scissors 101, as shown in FIG. 10, is formed of two shear bodies 102, 102 joined to each other, where each shear body 102 is comprised of a blade 103 at a front end and a finger grip 104 at a back end. In other words, each shear body 102 is formed in the order of a blade 103, a shank 105 and a finger grip 104 from a front end A to a back end B.

Each of the two finger grips 104, 104 of hairdressing scissors 101 is used to insert one finger, however, since both are made smaller than those on the scissors for general office use, there is almost no play between the finger and the finger grip 104 when the finger is inserted therethrough. Because the hairdressing scissors are operated by small opening and closing movements when cutting the hair, if there is a play between the finger and the finger grip, the hairdressing scissors cannot follow such small and rapid movements. Therefore, each finger grip is made comparatively small so that it closely fits the thickness of the finger.

However, the finger size of a hairdresser varies from person to person. Thus, the same hair cutting scissors may be too large in the finger grip for those with small fingers and too small for those with big fingers. Since the thickness of the fingers varies by each user, it is preferable to have finger grips with various shapes and sizes to accommodate the fingers of prospective users.

Accordingly, the applicant of the present invention has filed a patent application (Japanese Patent Application No. 2001-233262) that discloses the scissors which is capable of changing the size of the finger grips by having a slit on each finger grip. In this application, as shown in FIG. 11, a finger grip 204 includes a slit 206 to change the size of the finger grip 204. However, since the slit 206 creates a gap on the finger grip 204, the finger either will hit this gap when the finger contacts or caught by the slit 206, causing discomfort to the finger or adversely affecting operability of the scissors.

Due to this problem, in this prior application, other ideas are also proposed to eliminate the discomfort and the caught caused by the gap at the slit. For example, as shown in FIG. 12, end portions 207, 207 of the slit are formed in a partially cut-out manner so that the end portions engage with one another to either, thereby eliminating the gap or making the gap smaller. Further, as shown in FIG. 13, another idea is proposed in which a thin rubber tube 210 is incorporated to bridge between the end portions of slit 206 to fill in the gap, where the rubber tube has a sufficient length to cover the variations of the of gap.

However, to apply such ideas to the finger grip is time consuming, and the gap created by the slit still causes an uncomfortable feeling on the fingers of the users.

Further, when inserting a finger through the finger grip, the finger grip cannot be tightened any further when the end portions of the slit contact with one another. Moreover, when the finger grip is widened, since the gap has to be increased, the measures to prevent the finger from being caught in the gap as shown in FIGS. 12-13 may become ineffective.

Further, the finger grips are typically parallel to one another as shown by the two finger grips 104, 104 in FIG. 14 (within the context of this application, a direction of a line L perpendicular to a surface Sa of the finger grip 104 shown in FIG. 15 is referred to as a “finger grip direction”). However, when the two finger grips are aligned in the same direction as shown in FIG. 14, the direction L of the finger grip 104 becomes different from a direction M of the finger as shown in FIG. 16, making it difficult to insert the fingers as well as execute the opening and closing movements of the scissors.

In view of the above problems, it is an object of the present invention to provide a pair of hairdressing scissors which is capable of easily accommodating the hands as well as the fingers of the users such as the thickness and length of the fingers by bending the finger grips to a desired size and shape. Further, it is another object of the present invention to provide a pair of hairdressing scissors that does not have much limitations when changing the size of the finger grips. Further, it is another object of the present invention to provide a pair of hairdressing scissors with finger grips that do not cause any discomfort to the fingers.

### DISCLOSURE OF THE INVENTION

In order to solve the above subject, the hairdressing scissors of the present invention is comprised of a slit on each finger grip. Further, the finger grip is soft and has a flexible shape which enables plastic deformation so that the finger grip can be either widened or narrowed. Both end portions of the slit on the finger grip are formed so that each side surface of the end portion passes one another.

In order to make the finger grip is more easily deformed, the cross sectional shape or thickness of the finger grip can be adjusted. Further, the finger grip can be deformed either directly by hand without using a tool or indirectly by using a tool.

Since the finger grip can be either loosen or tighten, each hairdresser can create the finger grip to fit his or her own finger, resulting in a pair of hairdressing scissors with finger grips that match with each user's fingers.

Further, since both end portions of the slit are so positioned that the side surface of each end portion passes one another, the ends will not contact with each other when the finger grip is tightened, thereby eliminating the problem that the finger grip cannot be further tightened because the end portions contact each other.

Further, since the side surface of the end portions of the slit pass one another, a gap E (FIG. 5) created by the slit is small, and an overlap F is created by the end portions passing one another, a finger will not fall into the gap or be caught by the gap.

Further, since the side surfaces of the end portions of the slit pass one another, a difference in a surface level will not be formed at the location of the slit on the inner surface of the finger grip as shown by a reference character P in FIG. 1. Thus, the user will not feel any discontinuity of the slit in the finger grip, thus, the user feels comfortable.

Moreover, even when the finger grip is loosened, the finger will not fall into the gap or caught by the gap or there is no difference in a surface level in the finger grip as long as the overlap F remains on the finger grip.

Further, the end portions of the finger grip on the stationary shear body can be extended to form a finger brace. Since the end portions of the slit pass one another, one end portion can be extended without being interfered by the other end portion. Thus, the finger brace can be formed by the extended portion with desired length and shape.

Moreover, one end portion of the slit on each of the two finger grips can be extended to form two finger braces. This is called spectacle scissors since the finger brace is established on each of the finger grips. In other words, one pair of spectacle scissors can be used by a left-handed as well as a right-handed person.

Further, when the slit is established at the back end of the finger grip and the side where the finger is inserted in the finger grip is represented as a front side of the haircutting scissors, an end portion of each finger grip close to the contact point between the two finger grips can be placed in the front side than the other end portion.

According to this structure, as shown by a dotted line in FIG. 6, the two finger grips are inclined with one another, where the direction of the finger grips becomes similar to the direction of the fingers inserted (see FIG. 8), thus, allowing the fingers to be easily inserted and the opening and closing movements of the scissors can be easily performed.

### BRIEF DESCRIPTION OF THE DRAWINGS

FIG. 1 is a diagram showing a pair of hairdressing scissors in the first embodiment.

FIG. 2 is a diagram showing the bottom of the pair of hairdressing scissors of FIG. 1.

FIG. 3 is a perspective view showing a portion of the pair of hairdressing scissors of FIG. 1.

FIG. 4 is also a perspective view showing a portion of the pair of hairdressing scissors of FIG. 1.

FIG. 5 is the same drawing as that of FIG. 2, which explains a gap E and an overlap F formed by the two end portions of the finger grip.

FIG. 6 is also the same drawing as that of FIG. 2, which shows the situation where the nut is deleted and the finger grip is inclined.

FIG. 7 is a diagram showing two finger grips inclined from one another, indicating that the directions of the finger grips are not in parallel.

FIG. 8 is a drawing explaining that a direction L of the finger grip and a direction M of the user's finger become relatively close to one another when the finger grips of FIG. 7 are incorporated.

FIG. 9 is a diagram showing a pair of hairdressing scissors in the second embodiment.

FIG. 10 is a diagram explaining a typical pair of hairdressing scissors.

FIG. 11 is a diagram showing a finger grip which includes a slit.

FIG. 12 is a diagram showing a finger grip which includes a slit.

FIG. 13 is a diagram showing the slit which is bridged by a rubber tube.

FIG. 14 is a diagram showing that the directions of the finger grips are in parallel.

FIG. 15 is a diagram for explaining a direction L of the finger grip.

FIG. 16 is a diagram for explaining that the direction L of the finger grip and a direction M of the finger are relatively apart when the finger grips are parallel with one another.

### BEST MODE FOR IMPLEMENTING THE INVENTION

Next, the hairdressing scissors, i.e., an embodiment of the present invention, will be explained.

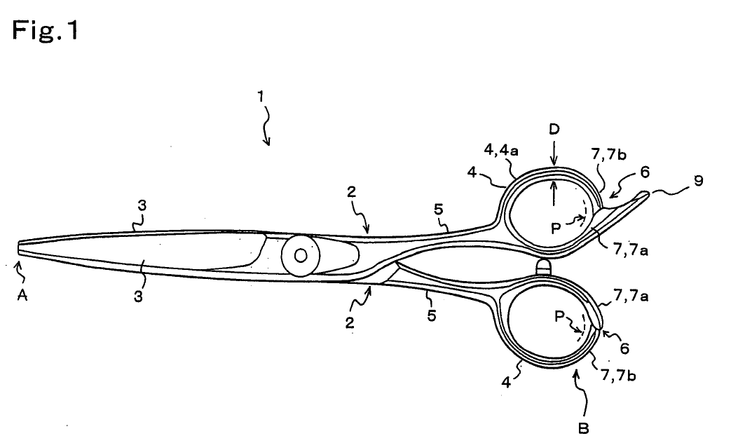

The first embodiment of hairdressing scissors shown in FIG. 1 has two shear bodies 2, 2 joined to one another, where each of the shear bodies 2 is comprised of a blade 3 at a front end A and a finger grip 4 at a back end B. In other words, each shear body 2 is formed in the order of a blade 3, a shank 5, and a finger grip 4 from the front end A to the back end B.

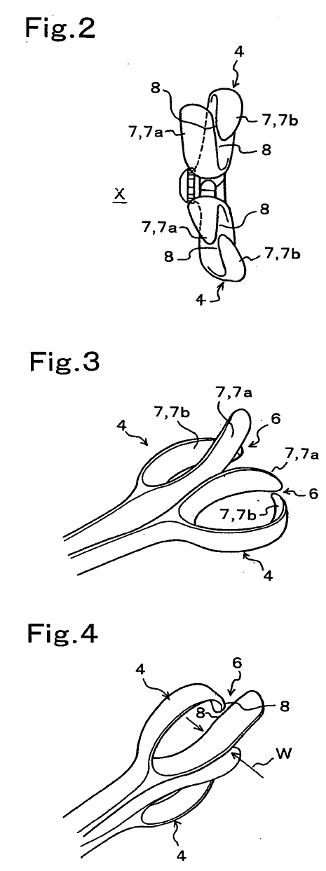

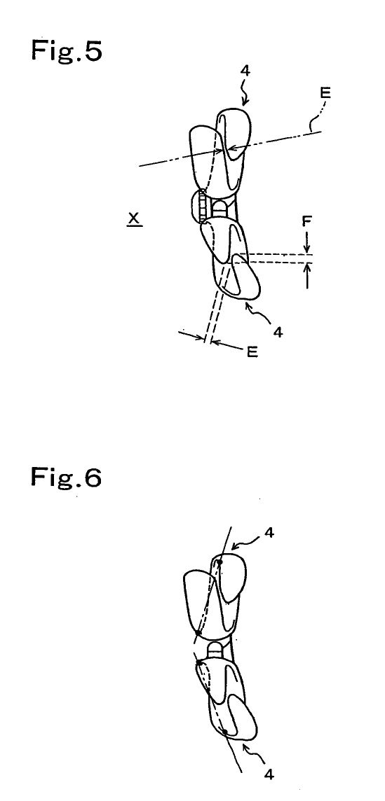

A slit 6 is established at the back end of each of the finger grips 4, 4 as shown in FIGS. 1-4. Further, as shown in FIG. 5, the slit 6 is formed in such a way that side surfaces 8, 8 of both end potions 7, 7 pass one another with a small gap E. Thus, the end portions 7, 7 create an overlap F. Further, when the side where the fingers are inserted into the finger grips 4, 4 is represented as a front side X (FIG. 5), end portions 7a, 7a that are on the sides that the finger grips 4, 4 contact with one another are positioned in the front side than the other end portions 7b, 7b.

Further, the finger grips 4 are made of material so that the finger grips 4 can be plastic deformed to be widened or narrowed. The thickness D (FIG. 1) of the finger grips is slightly decreased to promoted this plastic deformation. This is because when the thickness D of the finger grip is large, the deformation of the finger grip becomes more difficult even if flexible material is used. Also, the thickness and shape of the finger grip can be appropriately determined depending upon whether the size of the finger grip will be changed manually or by a tool. In the present embodiment, the thickness of the finger grip is decreased, and instead, a width W on the inner surface of the finger grip (FIG. 4) is widened.

Further, the end portion of the finger grip on the stationary blade at a side closer to the moving blade is extended to form a finger brace 9 as shown in FIGS. 1 and 3-4.

Further, inner surfaces of the end portions 7, 7 of the finger grip 4 are formed to be flash with one another so that the inner surface thereof will not form a bump. Further, as shown by a reference character P in FIG. 1, an area of the slit 6 is formed as though it is continuous.

The way of using the hairdressing scissors 1 according to the above structure noted above is explained as follows.

The finger grip 4 of the pair of hairdressing scissors 1 can be loosened or tightened to accommodate the size of the finger of each user. When this is done manually, the fingers of both hands are inserted into one finger grip to widen the grip, or the finger tips of both hands pinch finger grip 4 to tighten the grip. Consequently, the size of the finger grip 4 is varied to accommodate the thickness of the finger of the individual user. When the finger grip 4 is difficult to loosen or tighten without the use of a tool as explained above, the size of the finger grip can be changed by using an appropriate tool.

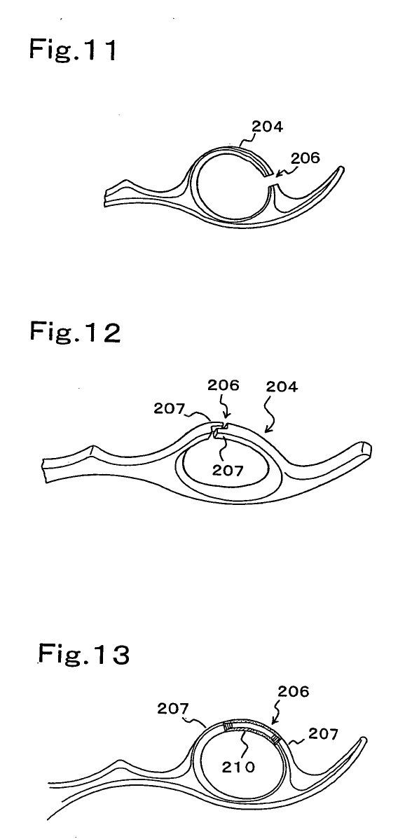

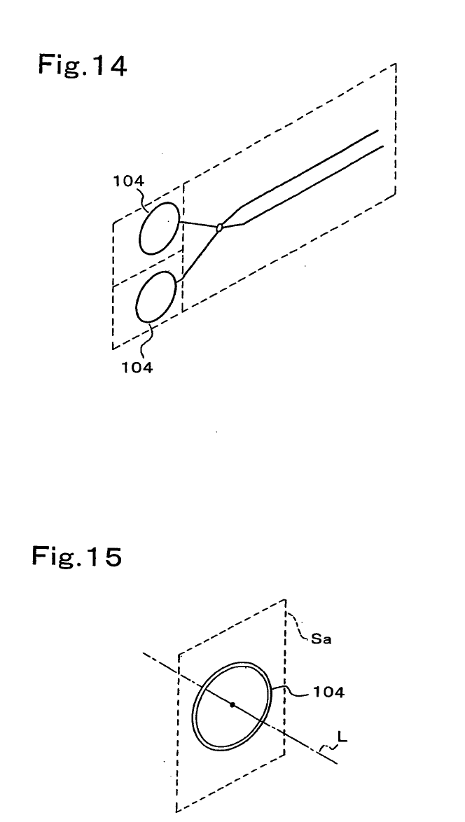

Further, when tightening the finger grip 4, it can theoretically be tightened without limit since the end portions 7, 7 will not contact each other. Moreover, when widening the finger grip, a gap wide enough to catch the finger as shown in FIG. 11 will not be created since the end portions 7, 7 pass one another unless the finger grip is extremely widened.

Further, since the side surfaces 8, 8 of the end portions 7, 7 are positioned to pass one another, the inner surfaces at the slit 6 are flush with one another so as not to form a bump (see reference character P of FIG. 1). Consequently, the area of the slit 6 as shown by the reference character P of FIG. 1 is in the situation as if the slit were continuous so long as the finger grip 4 is not extremely widened. Accordingly, the slit 6 is not obvious when the finger is inserted through the finger grip 4 and the finger itself will hardly feel the slit.

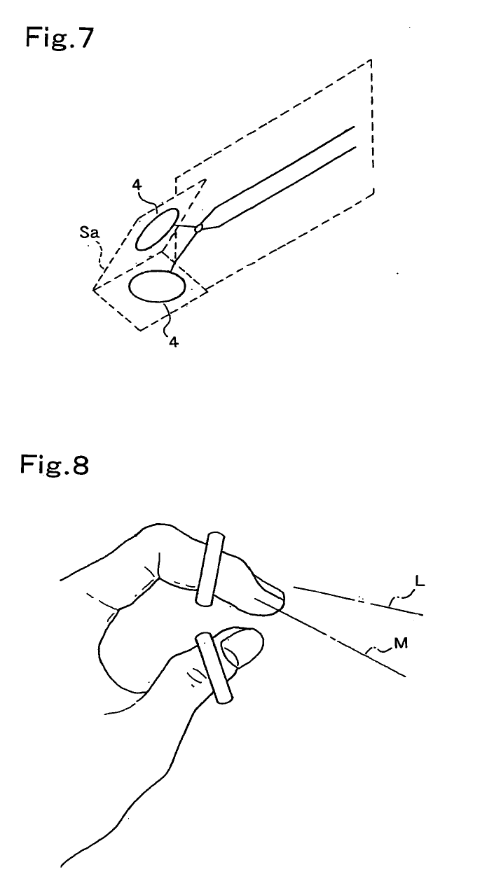

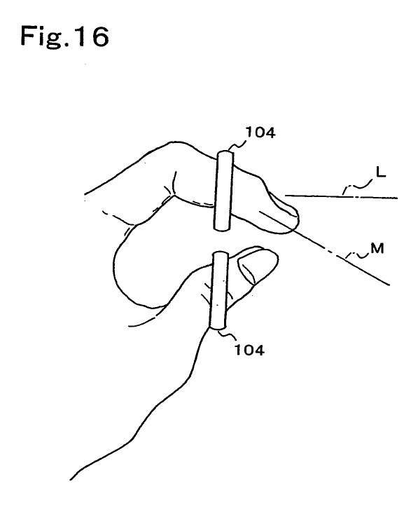

Further, the passing state of the end portions 7, 7 is established in such a way that the end portions 7a, 7a located at the sides close to the contact point of the two finger grips 4, 4 are located in the front side than the other end portions 7b, 7b. In this configuration, the two finger grips are in the situation similar to the slanted condition shown by the dotted line of FIG. 6. These inclined finger grips create condition similar to the slanted condition shown in FIG. 7. When the finger grips are inclined in this manner, a direction L of the finger grip becomes similar to a direction M of the finger when the finger is inserted through the finger grip as shown in FIG. 8, which allows the finger to be easily inserted as well as enables to easily open and close the hairdressing scissors. When comparing this feature to an ordinary pair of hairdressing scissors where the finger grips are not inclined, the direction L of the finger grip is different from the direction M of the finger as shown in FIG. 16, which makes it difficult to insert the finger through the finger grip as well as to execute the opening and closing movements of the scissors.

As described above, in the hairdressing scissors of the present embodiment, since the direction of the finger is slanted as shown in FIG. 6 by utilizing the end portions of the slit on the finger grip where they pass one another, the finger can easily be inserted through the finger grip and the open and close movements of the scissors can be easily performed.

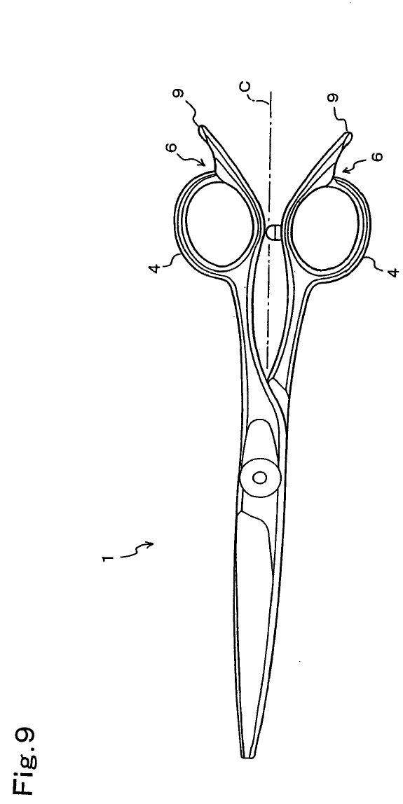

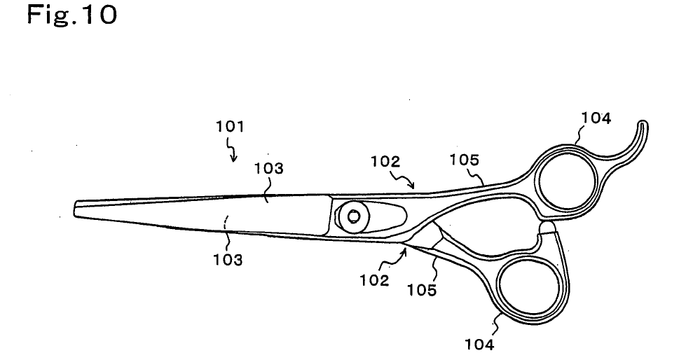

The pair of hairdressing scissors in the second embodiment shown in FIG. 9 includes finger braces 9, 9 which are created by extending the end portion on each of the two finger grips 4, 4. This embodiment of hairdressing scissors 1 comprises the same structure as the pair of hairdressing scissors in the first embodiment except that this embodiment has two finger braces 9, 9.

In the hairdressing industry, generally the word “spectacle” means “spectacle scissors”, which indicates a pair of hairdressing scissors formed with two blades with almost identical shanks and finger grips which are symmetrical relative to a center line C of FIG. 9. When the same pair of scissors are used either the left hand or right hand, the stationary blade and the moving blade are interchanged so that the finger grip has to be changed as well. By the pair of scissors shown in FIG. 9, since the finger brace is formed on each of the finger grips, one pair of scissors can be used by both a left handed person and a right handed person.

1. A pair of hairdressing scissors having two shear bodies connected to each other each having a blade at a front end and a finger grip at a back end, comprising:
a slit formed on each of the finger grips where the finger grip being configured by a shape and material to be flexible enough for plastic deformation to be widened or narrowed;
wherein both end portions of said slit are so configured that a side surface of each end portion passes one another.

2. A pair of hairdressing scissors as defined in claim 1, wherein one end portion of the finger grip of a blade that is stationary is extended to form a finger brace.

3. A pair of hairdressing scissors as defined in claim 1, wherein one end portion of each of the two finger grips is extended to form a finger brace.

4. A pair of hairdressing scissors as defined in either one of claims 1-3, wherein the slit is established at the back end of the finger grip, and a side where a finger is inserted through the finger grip to hold the scissors in place is represented as a front side, an end portion of the finger grip at a side closer to a contact point between the two finger grips is positioned in the front side than other end portion.
